(19) United States
(12) Patent Application Publication
(10) Pub. No.: US 2020/0409174 A1
(43) Pub. Date: Dec. 31, 2020

(54) SPECTACLE LENS DESIGN SYSTEM

(71) Applicant: HOYA LENS THAILAND LTD., Pathumthani (TH)

(72) Inventors: Shinichiro TAGUCHI, Shinjuku-ku (JP); Takao TANAKA, Shinjuku-ku (JP)

(73) Assignee: HOYA LENS THAILAND LTD., Pathumthani (TH)

(21) Appl. No.: 17/022,896

(22) Filed: Sep. 16, 2020

Related U.S. Application Data
(63) Continuation of application No. PCT/JP2019/013564, filed on Mar. 28, 2019.

(30) Foreign Application Priority Data
Mar. 30, 2018 (JP) 2018-070036

(51) Int. Cl. G02C 7/02

(52) U.S. Cl. CPC G02C 7/027

(57) ABSTRACT

A spectacle lens design system includes: an information acquisition device; a first design data deriving device deriving first design data of an eyeball-side surface; a first thickness information deriving device deriving first values of wall thickness and edge thickness of the spectacle lens; a second design data deriving device deriving second design data of the eyeball-side surface, which has higher accuracy than the first design data, based on the prescription value of the wearer and the design data of the object-side surface; and a second thickness information deriving device deriving second values of the wall thickness and edge thickness of the spectacle lens based on the derived second design data of the eyeball-side surface, the design data of the object-side surface, and the minimum wall thickness and minimum edge thickness information of the spectacle lens.

### TECHNICAL FIELD

The present disclosure relates to a spectacle lens design system.

### BACKGROUND ART

Spectacle lens production factories receive orders for producing of spectacle lenses from optician's shops using a lab management system (LMS), and manage producing processes and devices in the factories (for example, Patent Literature 1).

On the other hand, there is business in which spectacle lens design vendors provide spectacle lens manufacturers with lens design systems (LDS), and the spectacle lens manufacturers design and produce spectacle lenses by causing the LDS to execute calculations. The LDS calculation process is generally performed on a server (in a factory or a server farm) or on a web service, and a result of the LDS calculation process is output to the LMS.

Meanwhile, when receiving an order from a user, the optician's shop checks whether a lens produced by the order can be mounted in a frame desired by the user without any problem in terms of strength and whether an appearance of the lens is not impaired when being mounted. Therefore, the optician's shop transmits ordering information to a manufacturer before placing a final order to the manufacturer. Further, the manufacturer creates design data of a spectacle lens based on the received information, and transmits data regarding a shape of the lens such as “wall thickness and edge thickness”, which may be a problem when mounted in the frame, to the optician's shop. The optician's shop and the user finally determine whether to order the lens to the manufacturer based the data regarding the shape returned from the manufacturer.

### CITATION LIST

### Patent Literature

Patent Literature 1: JP 2014-085574 A

### SUMMARY

### Technical Problem

It is considered that the manufacturer desires to quickly return such data to the optician's shop in order to avoid losing orders. Whether data can be returned quickly depends on a calculation speed of a lens design system, and LDS vendors are required by manufacturers to improve the calculation speed in the case of LDS business.

Therefore, one embodiment of the present disclosure relates to a spectacle lens design system capable of quickly calculating wall thickness and edge thickness of a spectacle lens in accordance with a frame shape.

### Solution to Problem

One embodiment of the present disclosure relates to a spectacle lens design system including: an information acquisition means for acquiring a prescription value of a wearer, frame shape data, information on minimum wall thickness and minimum edge thickness of a spectacle lens, and design data of an object-side surface; a first design data deriving means for deriving first design data of an eyeball-side surface based on the prescription value of the wearer and the design data of the object-side surface; a first thickness information deriving means for deriving first values of wall thickness and edge thickness of the spectacle lens in accordance with the frame shape data based on the derived first design data of the eyeball-side surface, the design data of the object-side surface, and the minimum wall thickness and minimum edge thickness information of the spectacle lens; a second design data deriving means for deriving second design data of the eyeball-side surface, which has higher accuracy than the first design data, based on the prescription value of the wearer and the design data of the object-side surface; and a second thickness information deriving means for deriving second values of the wall thickness and edge thickness of the spectacle lens based on the derived second design data of the eyeball-side surface, the design data of the object-side surface, and the minimum wall thickness and minimum edge thickness information of the spectacle lens.

### Advantageous Effects

According to one embodiment of the present disclosure, it is possible to provide the spectacle lens design system capable of quickly calculating the wall thickness and edge thickness of the spectacle lens in accordance with the frame shape.

### BRIEF DESCRIPTION OF DRAWINGS

FIG. 1 is a functional block diagram illustrating a schematic configuration of a spectacle lens ordering system 1 according to an embodiment of the present disclosure.

FIG. 2 is a block diagram illustrating a hardware configuration example of an LDS 100.

FIG. 3 is a block diagram illustrating a software configuration example of the LDS 100.

FIG. 4 is a diagram illustrating an outline of an optical performance power distribution table 1210.

FIG. 5 is a block diagram illustrating a software configuration example of an LMS 200.

FIG. 6 is a block diagram illustrating a software configuration example of a terminal device 300.

FIG. 7 is a flowchart illustrating an example of an operation of the spectacle lens ordering system 1 according to the embodiment of the disclosure.

FIG. 8 is a flowchart illustrating an example of an operation of a provisional design information calculation unit 120 of the LDS 100 in provisional design data calculation S106.

FIG. 9 is a flowchart illustrating an example of an operation of a provisional thickness information calculation unit 124 of the LDS 100 in S107.

FIG. 10 is a flowchart illustrating an example of an operation of an eyeball-side surface final design data calculation unit 142 of the LDS 100 in S121.

### DESCRIPTION OF EMBODIMENTS

Hereinafter, preferred embodiments of the present disclosure will be described in detail with reference to the drawings. Note that the same or corresponding parts in the drawings are designated by the same reference signs, and the description thereof will not be repeated.

### [Spectacle Lens Ordering System]

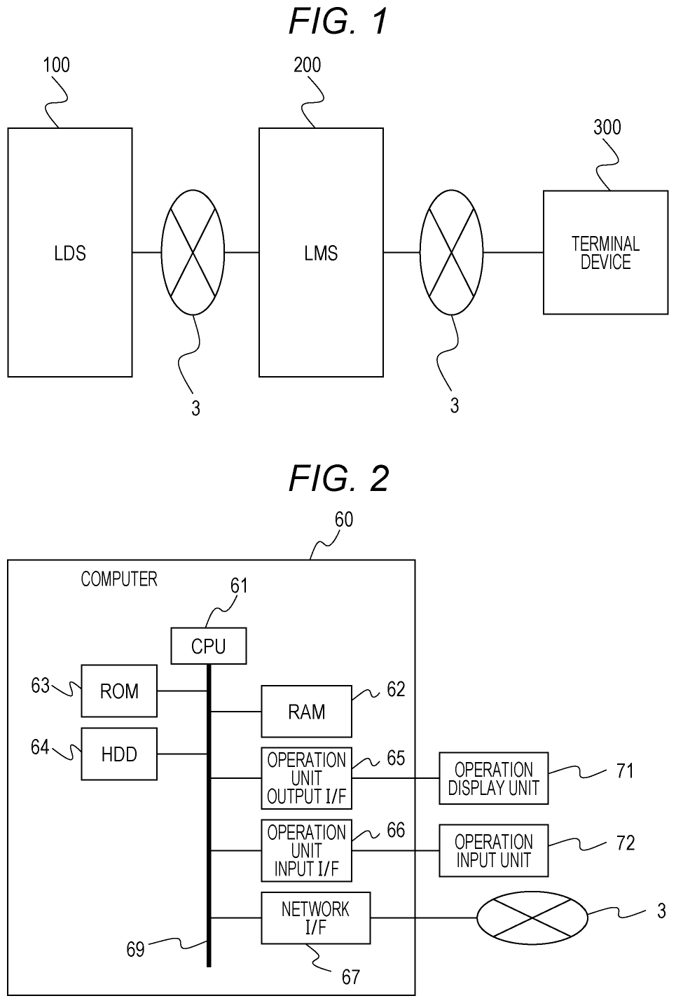

FIG. 1 is a functional block diagram illustrating a schematic configuration of a spectacle lens ordering system 1 according to an embodiment of the present disclosure.

The spectacle lens ordering system 1 includes a spectacle lens design system (hereinafter also referred to as “LDS”) 100, a lab management system (hereinafter also referred to as “LMS”) 200, and a terminal device 300.

The LDS 100 and the LMS 200 are connected to each other via a network 3.

Further, the LMS 200 and the terminal device 300 are connected to each other via the network 3.

Examples of the network 3 can include the Internet based on a general-purpose protocol such as TCP/IP, intranet, a local area network (LAN), and a communication line network such as a telephone line.

The LDS 100 may be installed in a factory of a spectacle lens manufacturer or may be installed outside.

The LMS 200 is installed, for example, in the factory of the spectacle lens manufacturer.

The terminal device 300 is installed in, for example, an optician's shop.

<LDS>

### [Hardware Configuration of LDS]

FIG. 2 is a block diagram illustrating a hardware configuration example of the LDS 100.

The LDS 100 includes, for example, a computer 60 that controls an overall operation of the LDS 100, an operation display unit 71, and an operation input unit 72.

The computer 60 includes a CPU 61, a RAM 62, a ROM 63, an HDD 64, an operation unit output I/F 65, an operation unit input I/F 66, and a network I/F 67.

The central processing unit (CPU) 61 executes various programs. The CPU activates a system based on a boot program stored in the read only memory (ROM) 62. Further, the CPU 61 reads out a control program stored in the hard disk drive (HDD) 64 and executes a predetermined process using the random access memory (RAM) 62 as a work area.

Various control programs are stored in the HDD 64. Further, the HDD 64 stores data acquired from outside the device via the network I/F 67 and a calculation result of the control program.

The operation unit output I/F 65 performs data output communication control to the operation display unit 71. The operation unit input I/F 66 performs data input communication control from the operation input unit 72. The network I/F 67 is connected to the network 3 and controls input and output of information via the network 3. In this manner, the respective components 61 to 67 are arranged on a system bus 69.

The operation display unit 71 is a display interface for the user, which includes a display device such as a liquid crystal display (LCD) or a light emitting diode (LED). The operation input unit 72 is an instruction input interface from a user, which is provided with an input device such as a touch panel and a hard key.

The LDS 100 can be realized by a computer 60 such as a server computer and a personal computer connected to the operation display unit 71 and the operation input unit 72.

Further, the CPU 61 reads out the control program stored in the HDD 64 into the RAM 62 and executes the control program, whereby each function of each unit of the LDS 100 can be realized. Note that a configuration of a portion that is not related to the essence of the present disclosure is omitted and not illustrated in each drawing.

### [Software Configuration of LDS]

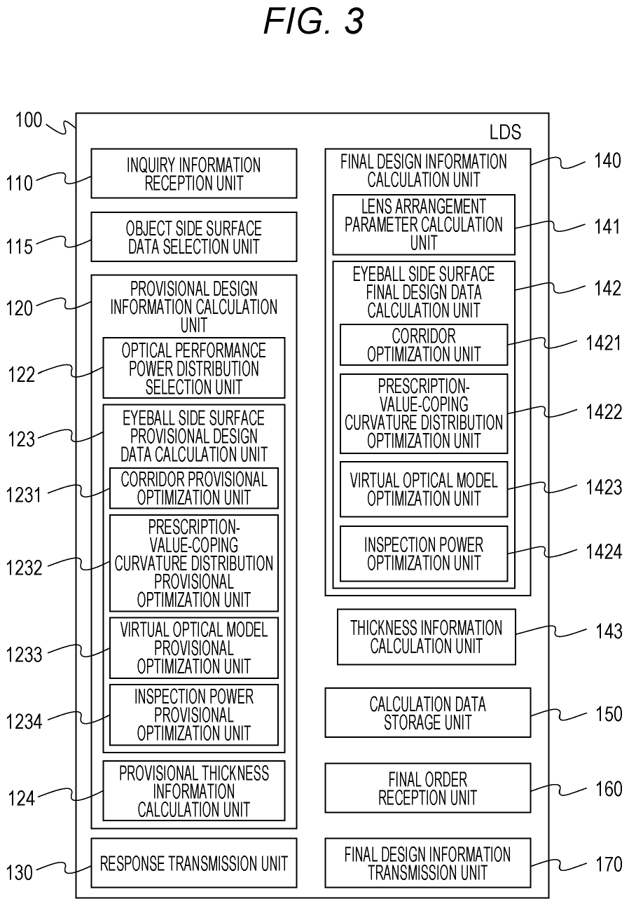

FIG. 3 is a block diagram illustrating a software configuration example of the LDS 100. Software (control program) corresponding to each functional block illustrated in FIG. 3 is stored in the ROM 63 or the HDD 64 of the LDS 100. Functions to be described below of the respective functional blocks illustrated in FIG. 3 are realized on the LDS 100 by the CPU 61 executing the software stored in the ROM 63 or the HDD 64. Note that FIG. 3 illustrates a software configuration particularly related to the description of the present embodiment.

As illustrated in FIG. 3, the LDS 100 includes, as a software configuration, an inquiry information reception unit 110, an object-side surface data selection unit 115, a provisional design information calculation unit 120, a response transmission unit 130, a final design information calculation unit 140, a calculation data storage unit 150, a final order reception unit 160, and a final design information transmission unit 170.

The LDS 100 calculates a wall thickness and an edge thickness corresponding to a frame shape by the provisional design information calculation unit 120 in response to inquiry information from the optician's shop, and transmits response information. Further, the LDS 100 uses the final design information calculation unit 140 to calculate design information reflecting a more detailed condition. Since the provisional design information calculation unit 120 and the final design information calculation unit 140 are divided to perform the design calculation in this manner, it is possible to quickly make a response to an inquiry from the optician's shop.

The inquiry information reception unit 110 receives inquiry information from the terminal device 300 via the LMS 200.

Examples of the inquiry information include information provided from the terminal device 300 and information provided from the LMS 200.

Examples of the information provided from the terminal device 300 include (1) information on a type of a spectacle lens, (2) a prescription value of a wearer, (3) frame information, (4) information on a spectacle wearing condition of a user, and (5) other user-desired information.

Examples of (1) the information on the type of spectacle lens include a manufacturer name, a model number, and material information of a spectacle lens.

Examples of (2) the prescription value of the wearer include spherical power (hereinafter, also referred to as “S power”), cylindrical power (hereinafter, also referred to as “C power”), a cylindrical axial direction, prismatic power, and prism base setting. However, when the spectacle lens selected by the user is a progressive addition lens, the prescription value of the wearer includes addition power that indicates a power difference between a distance portion and a near portion.

Examples of (3) the information on the frame include frame shape data selected by the user.

(4) The information on the spectacle wearing condition of the user includes a frame corneal to vertex distance (Frame Corner Vertex Distance), a pantoscopic angle indicating an angle between a vertical line of a face and a frame, a frame tilting angle (frame bending angle), measurement values relating to the frame such as a rim and a groove position, and layout information.

Examples of (5) the other user-desired information include information on wall thickness and edge thickness of a spectacle lens desired by the user.

Note that the layout information is information configured to align an optical center of a spectacle lens with a position of wearer's pupil, and indicates a position of a fitting point with a geometric center of a frame (frame center) as a reference.

Examples of the layout information include a pupillary distance (hereinafter, also referred to as “PD”), an eye point (visual point), and an optical centre distance (hereinafter also referred to as “OCD”).

In the case of the progressive addition lens, examples of the layout information include a distance vision eye point (distance vision visual point) and a near vision eye point (near vision visual point). Note that the optical centre distance may be a distance between fitting points in the case of the progressive addition lens.

Examples of the information provided from the LMS 200 include information on minimum wall thickness and minimum edge thickness of a spectacle lens set in advance in the LMS according to a material of the spectacle lens, and information on design data of an object-side surface set in advance in the LMS according to a type of the spectacle lens and a prescription value of the wearer.

As the information on the minimum wall thickness and minimum edge thickness, minimum wall thickness and minimum edge thickness for securing sufficient strength are set according to properties of the material of the spectacle lens. In the LMS 200, the information on the minimum wall thickness and minimum edge thickness is selected depending on the material of the spectacle lens.

The information on the object-side surface design data may be information associated with design data of an object-side surface such as information of a semi-finished lens, and may be, for example, a section of the semi-finished lens.

The semi-finished lens of the progressive power spectacle lens is prepared for each section obtained by dividing a range of vertex power into about five stages.

For example, the sections of five stages of I to V are divided according to the vertex power (spherical power SPH and cylindrical power CYL) of the progressive power spectacle lens. The following Table 1 shows an example of the correspondence between the section and a base curve of the semi-finished lens (a mean surface refractive power of a front surface at a measurement reference point for a distance portion). In Table 1, a progressive surface having a predetermined base curve is assigned for each section. That is, one kind of semi-finished lens whose front surface is processed as a progressive surface is prepared for each of these sections. Note that the units of the vertex power and the base curve are diopters (D). In addition, Table 1 is an example of the case where a refractive index is 1.60.

TABLE 1

| Section | Vertex Power | Base Curve |
|---|---|---|
| I | −10.00 to −6.25 | 0.50 |
| II | −6.00 to −2.25 | 2.00 |
| III | −2.00 to +1.00 | 4.00 |
| IV | +1.25 to +3.00 | 5.00 |
| V | +3.25 to +6.00 | 6.00 |

The object-side surface data selection unit 115 selects object-side surface data from the information on the object-side surface design data. For example, when receiving a section of the semi-finished lens, the object-side surface data selection unit 115 selects the object-side surface data corresponding to the section of the semi-finished lens stored in advance.

The provisional design information calculation unit 120 includes an optical performance power distribution selection unit 122, an eyeball-side surface provisional design data calculation unit 123, and a provisional thickness information calculation unit 124. In the provisional design information calculation unit 120, information on a wall thickness and an edge thickness according to the frame shape included in the inquiry information is calculated.

The optical performance power distribution selection unit 122 acquires an optical performance power distribution based on the information on the type of the spectacle lens and the prescription value of the wearer.

The optical performance power distribution is selected from an optical performance power distribution table 1210.

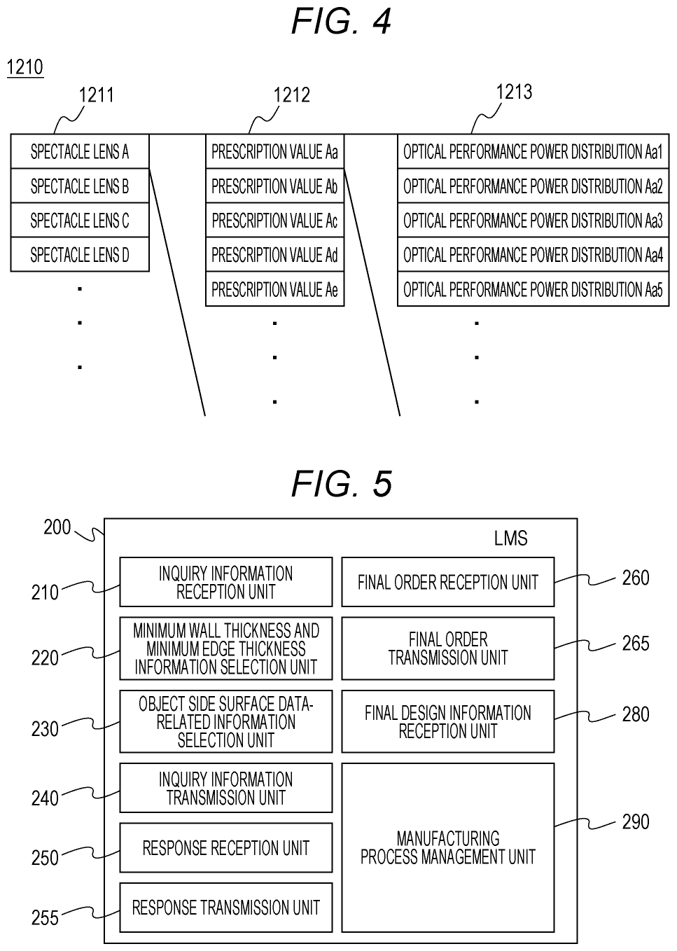

FIG. 4 is a diagram illustrating an outline of the optical performance power distribution table 1210.

In the optical performance power distribution table 1210, an optimum optical performance power distribution 1213 is stored in a storage unit in association with a spectacle lens type 1211, wearer's prescription value 1212, and the like.

The eyeball-side surface provisional design data calculation unit 123 calculates provisional design data of an eyeball-side surface based on the optical performance power distribution selected based on the prescription value of the wearer in the optical performance power distribution selection unit 122 and the object-side surface design data.

Here, a method of calculating the provisional design data of the eyeball-side surface performed by the LDS 100 will be described.

In the LDS 100, the optical performance power distribution is set according to the type of the spectacle lens.

Further, a design program, which receives inputs of a prescription value and a lens arrangement parameter and derives design data of the eyeball-side surface having an optical performance power distribution and a curvature distribution corresponding thereto, is set in the LDS 100.

In the eyeball-side surface provisional design data calculation unit 123, a default value is used as the value of the lens arrangement parameter.

Specifically, the eyeball-side surface provisional design data calculation unit 123 includes: a corridor provisional optimization unit 1231 that optimizes a corridor with respect to addition power based on the prescription value; a prescription-value-coping curvature distribution provisional optimization unit 1232 that optimizes a curvature distribution of the eyeball-side surface with respect to the prescription value; a virtual optical model provisional optimization unit 1233 which performs optimization in consideration of an appearance through an eyeball model; and an inspection power provisional optimization unit 1234 that optimizes power at an inspection position. The eyeball-side surface provisional design data calculation unit 123 performs optimization by each of these units and executes convergence calculation so as to approach an ideal power distribution.

The eyeball-side surface provisional design data calculation unit 123 has a wide range of convergence conditions at the time of performing each type of the above optimization. It is possible to shorten calculation time by allowing the convergence condition to have a range.

The optimization of the corridor with respect to the addition power is executed only in the case of the progressive addition lens. The corridor provisional optimization unit 1231 cuts an addition power optimization element at a level that does not cause a large difference in wall thickness shape or an edge thickness, for example.

The prescription-value-coping curvature distribution provisional optimization unit 1232 calculates an optimum curvature distribution based on the object-side surface design data and the optical performance power distribution in the optimization of the eyeball-side surface curvature distribution with respect to the prescription value. At this time, the calculation time can be shortened by allowing the convergence condition to have a range.

The virtual optical model provisional optimization unit 1233 sets a virtual optical model constituted by the eyeball model and a spectacle lens model in the optimization in consideration of the appearance through the eyeball model, and determines a target position in consideration of a positional relationship between the eyeball model and the spectacle lens to perform optimization.

Further, the virtual optical model provisional optimization unit 1233 first sets the virtual optical model constituted by the eyeball model and the spectacle lens model. Note that the eyeball model is set based on the prescription value of the wearer. Specifically, for example, the eyeball model is selected from the profile of the eyeball model stored in advance, based on the prescription value (spherical power and cylindrical power). In addition, the spectacle lens model is set based on a type of the spectacle lens, a material (a refractive index of a substrate), a prescription value, a minimum wall thickness, a surface shape of the object-side surface determined according to a base curve, and a surface shape of the eyeball-side surface calculated by the optimization calculation in the previous stage. Further, the selected eyeball-side surface shape and the object-side surface shape determined according to the base curve are arranged to be spaced apart from each other with a minimum wall thickness. The spectacle lens is arranged based on further a lens bending angle, a lens pantoscopic angle, and a corneal to vertex distance which are lens arrangement parameters calculated from a frame measurement value of the wearer. In the virtual optical model provisional optimization unit 1233, values set as initial values in advance are used as the above wearing parameters. On the other hand, in a virtual optical model optimization unit 1423 to be described below, each value calculated by a lens arrangement parameter calculation unit 141 is used as the lens arrangement parameter.

The virtual optical model provisional optimization unit 1233 thins out the number of targets at the time of performing optimization using the eyeball model to about half the number of targets in the virtual optical model optimization unit 1423. As a result, it is possible to shorten the calculation time while reducing the influence on the edge thickness.

In the optimization of the power at the inspection position of the inspection power provisional optimization unit 1234, the inspection position is a distance power confirmation position and a near power confirmation position in a progressive addition lens, or is an optical center in a single focus lens. The inspection power provisional optimization unit 1234 expands a tolerance of the power optimization at the inspection position by about twice to three times compared with a tolerance of an inspection power optimization unit 1424. As a result, it is possible to shorten the calculation time while reducing the influence on the edge thickness.

The eyeball-side surface provisional design data calculation unit 123 calculates the eyeball-side surface provisional design data through the above optimization calculation.

The provisional thickness information calculation unit 124 calculates provisional values of the wall thickness and edge thickness of the spectacle lens in accordance with the frame shape data based on the provisional design data of the eyeball-side surface, the design data of the object-side surface, and the minimum wall thickness and minimum edge thickness of the spectacle lens.

The provisional value of the edge thickness when cut into the frame shape in the case of setting a predetermined wall thickness is calculated based on the object-side surface design data and the eyeball-side surface design data.

At this time, if an edge thickness of an uncut lens and an edge thickness of a lens cut along the frame do not satisfy desired conditions for the minimum wall thickness and minimum edge thickness of the spectacle lens, the provisional value of the edge thickness when being cut into the frame shape is calculated again by changing the conditions.

When the edge thickness of the uncut lens and the edge thickness of the lens cut along the frame satisfy the desired edge thicknesses, the desired wall thickness and the calculated edge thickness are stored.

If the edge thickness of the uncut lens and the edge thickness of the lens cut along the frame do not satisfy the desired edge thicknesses, the wall thickness is determined by adjusting a distance between reference points of the object-side surface design data and the eyeball-side surface design data such that the edge thickness in the frame shape becomes the desired edge thickness. Further, the wall thickness determined as the desired edge thickness is stored.

This reference point is set by each design maker, and for example, an optical center is set as the reference point.

The minimum wall thickness of the spectacle lens and the minimum edge thickness in the frame shape are set according to the type of the spectacle lens. The optimization calculation may be performed using these values of the minimum wall thickness and minimum edge thickness as desired values.

In addition, there is a case where an ordering side may specify a wall thickness and an edge thickness in a frame shape in accordance with a selected frame. In this case, values specified by the ordering side may be calculated as desired values. Note that if the wall thickness and the edge thickness in the frame shape specified by the ordering side are smaller than the minimum wall thickness and minimum edge thickness of the spectacle lens, it is desirable to use the set wall thickness and edge thickness in the frame shape as desired values.

In addition, there is a case where a minimum wall thickness, which is larger than the minimum wall thickness set according to the type of spectacle lens and is set in consideration of processing of the spectacle lens, is specified in the LMS 200. In this case, it is desirable to calculate the value of the minimum wall thickness specified in the LMS 200 as a desired value.

In addition, there is a case where a minimum edge thickness of an uncut lens is specified in the LMS 200 in consideration of the processing of spectacle lenses. In this case, it is desirable to further determine whether a minimum edge thickness of the spectacle lens before processing into the frame shape is satisfied and to determine the wall thickness and the minimum edge thickness in the frame shape by adjusting the distance between the optical centers of the object-side surface design data and the eyeball-side surface design data if the minimum edge thickness of the spectacle lens before processing into the frame shape is not satisfied.

The provisional design data of the eyeball-side surface, the provisional design information of the spectacle lens such as the wall thickness and the edge thickness, which are obtained by the provisional design information calculation 120, are stored in the calculation data storage unit 150.

The response transmission unit 130 transmits the provisional values of the wall thickness and edge thickness of the spectacle lens calculated by the provisional thickness information calculation unit 124.

The final design information calculation unit 140 includes the lens arrangement parameter calculation unit 141, the eyeball-side surface final design data calculation unit 142, and the thickness information calculation unit 143.

The lens arrangement parameter calculation unit 141 calculates a lens arrangement parameter including a relative positional relationship between the spectacle lens and the eyeball when wearing the spectacle based on the information on the spectacle wearing condition of the wearer such as the measurement value of the frame and the provisional design information of the spectacle lens obtained in the provisional design information calculation 120.

Examples of the lens arrangement parameter include a lens bending angle, a lens pantoscopic angle, and a corner vertex distance (hereinafter, also referred to as “CVD”).

Specifically, the lens arrangement parameter calculation unit 141 converts each of a frame bending angle, a lens pantoscopic angle, and a frame corneal to vertex distance, which are measurement values related to the frame, into each of the lens bending angle, the lens pantoscopic angle, and the corneal to vertex distance. This conversion is performed based on the provisional design information of the spectacle lens obtained in the provisional design information calculation 120, and information such as a frame shape, a rim or a groove position, lens power, a curvature distribution, a fitting point position, and a wall thickness is reflected thereon.

The corneal to vertex distance is a distance between a hack vertex of the spectacle lens and a corneal vertex of the eyeball model.

The eyeball-side surface final design data calculation unit 142 calculates final design data for the eyeball-side surface based on the optical performance power distribution selected based on the prescription value of the wearer in the optical performance power distribution selection unit 122, the object-side surface design data, the lens arrangement parameter, and the wall thickness and edge thickness calculated by the eyeball-side surface provisional design data calculation unit 123.

Specifically, the eyeball-side surface final design data calculation unit 142 includes: a corridor optimization unit 1421 that optimizes a corridor with respect to addition power based on the prescription value; a prescription-value-coping curvature distribution optimization unit 1422 that optimizes a curvature distribution of the eyeball-side surface with respect to the prescription value; a virtual optical model optimization unit 1423 which performs optimization in consideration of an appearance through an eyeball model; and an inspection power optimization unit 1424 that optimizes power at an inspection position.

The calculation of the final design data of the eyeball-side surface is basically executed by the same method as the method of calculating the provisional design data.

However, the final design data calculation unit 142 differs from the provisional design data calculation unit 123 in terms of the following points.

(1) The number of targets for convergence calculation is set to be larger than that of the provisional design data calculation unit 123 described above.

(2) A tolerance of the convergence calculation is set to a value smaller than that of the provisional design data calculation unit 123 described above.

(3) Calculation is executed in consideration of the calculated lens arrangement parameter.

With (1) and (2), the eyeball-side surface design data having a distribution more approximate to the optical performance power distribution is derived.

More specifically, in relation to (3), the virtual optical model optimization unit 1423 derives optimum design data of the eyeball-side surface in accordance with an individual wearer based on the lens arrangement parameter and the wall thickness and edge thickness calculated by the eyeball-side surface provisional design data calculation unit 123.

In other words, highly accurate convergence calculation is performed in consideration of more detailed conditions in the final design data calculation unit 142, and thus, the eyeball-side surface design data having a curvature distribution more approximate to the optical performance power distribution is derived.

The thickness information calculation unit 143 calculates values of the wall thickness and edge thickness of the spectacle lens based on the derived final design data of the eyeball-side surface, the design data of the object-side surface, and the minimum wall thickness and minimum edge thickness of the spectacle lens.

The thickness information calculation unit 143 performs the same processing as the provisional thickness information calculation unit 124 to calculate the values of the wall thickness and edge thickness of the spectacle lens, except that the final design data of the eyeball-side surface is used instead of the provisional design data of the eyeball-side surface.

The calculation data storage unit 150 stores the final design data of the eyeball-side surface and the final design information such as the wall thickness and edge thickness of the spectacle lens.

The final order reception unit 160 receives final order information from the ordering side.

When receiving the final order information, the final design information transmission unit 170 transmits the final design data of the eyeball-side surface and the final design information such as the wall thickness and the edge thickness of the spectacle lens.

<LMS and Terminal Device>

Similarly to the LDS 100, the LMS 200 and the terminal device 300 can be realized by the computer 60 such as a server computer and a personal computer connected to the operation display unit 71 and the operation input unit 72.

Further, the CPU 61 reads out the control program stored in the HDD 64 into the RAM 62 and executes the control program, whereby each function of each unit of the LMS 200 and the terminal device 300 can be realized. Note that a configuration of a portion that is not related to the essence of the present disclosure is omitted and not illustrated in each drawing.

Software (control program) corresponding to each functional block illustrated in the drawings is stored in the ROM 63 or the HDD 64 of the LMS 200 or the terminal device 300. Functions to be described below of the respective functional blocks illustrated in the drawings are realized on the LMS 200 or the terminal device 300 by the CPU 61 executing the software stored in the ROM 63 or the HDD 64.

FIG. 5 is a block diagram illustrating a software configuration example of the LMS 200.

As illustrated in FIG. 5, the LMS 200 includes, as a software configuration, an inquiry information reception unit 210, a minimum wall thickness and minimum edge thickness information selection unit 220, an object-side surface data-related information selection unit 230, an inquiry information transmission unit 240, a response reception unit 250, a response transmission unit 255, a final order reception unit 260, a final order transmission unit 265, a final design information reception unit 280, and a producing process management unit 290.

The inquiry information reception unit 210 receives inquiry information from the terminal device 300.

The minimum wall thickness and minimum edge thickness information selection unit 220 selects the minimum wall thickness and minimum edge thickness information based on the information on the type of the spectacle lens in the inquiry information of the terminal device 300.

The object-side surface data-related information selection unit 230 selects optimum design data of the object-side surface based on the information on the type of the spectacle lens in the inquiry information of the terminal device 300 and the prescription value of the wearer.

The inquiry information transmission unit 240 transmits the inquiry information of the terminal device 300, the minimum wall thickness and minimum edge thickness information, and the object-side surface design data to the LDS 100.

The response reception unit 250 receives the information on the wall thickness and edge thickness of the spectacle lens in accordance with the frame shape which is transmitted from the LDS 100.

The response transmission unit 255 transmits the information on the wall thickness and edge thickness of the spectacle lens to the terminal device 300.

The final order reception unit 260 receives the final order information transmitted from the terminal device 300.

The final order transmission unit 265 transmits the final order information to the LDS 100.

The final design information reception unit 280 receives the final design information transmitted from the LDS 100 in response to the final order information.

The producing process management unit 290 manages a producing process of the spectacle lens based on the final design information received from the LDS 100.

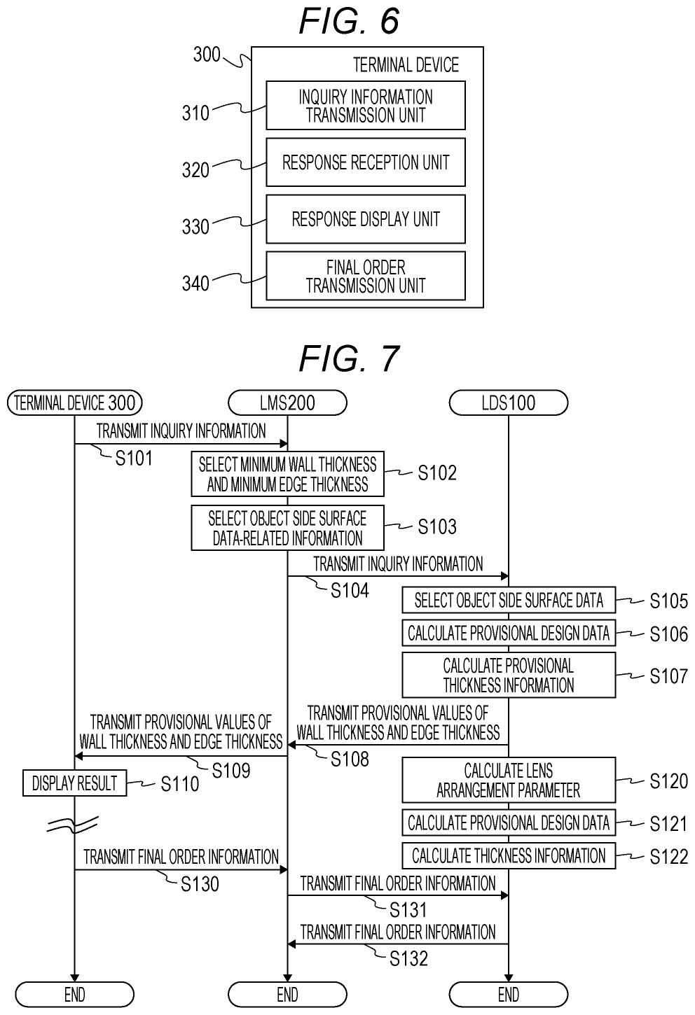

FIG. 6 is a block diagram illustrating a software configuration example of the terminal device 300.

As illustrated in FIG. 6, the terminal device 300 includes, as a software configuration, an inquiry information transmission unit 310, a response reception unit 320, a response display unit 330, and a final order transmission unit 340.

The inquiry information transmission unit 310 transmits the inquiry information described above.

The response reception unit 320 receives the information on the wall thickness and edge thickness of the spectacle lens in accordance with the frame shape.

The response display unit 330 displays the information on the wall thickness and edge thickness of the spectacle lens in accordance with the frame shape. A salesperson of the optician's shop in which the terminal device 300 is installed explains the specifications of spectacles to a user based on the information on the wall thickness and edge thickness of the spectacle lens and waits for user's determination on whether to purchase.

When the user indicates the intention for purchase, the final order transmission unit 340 is operated by a clerk of the optician's shop and transmits the final order information.

<Processing Flow>

A processing flow of the spectacle lens ordering system 1 described above will be described hereinafter.

FIG. 7 is a flowchart illustrating an example of an operation of the spectacle lens ordering system 1 according to the embodiment of the disclosure. The processing of each step in FIG. 7 is realized in each unit of the LDS 100, the LMS 200, and the terminal device 300 of the spectacle lens ordering system 1 as the CPU 61 reads out the software stored in the ROM 63 or the HDD 64 (software corresponding to each functional block illustrated in FIGS. 3, 5, and 6) to the RAM 62 and executes the read software. That is, the processing of each step is executed by the CPU.

In S101, the clerk of the optician's shop selects (1) the information on the type of the spectacle lens, (2) the prescription value of the wearer, (3) the frame information, (4) the information on the spectacle wearing condition of the user, and (5) the other inquiry information such as the user-desired information in accordance with user's desire, and transmits the inquiry information to the LMS 200 by the terminal device 300.

In S102, the minimum wall thickness and minimum edge thickness information selection unit 220 of LMS 200 selects the minimum wall thickness and minimum edge thickness information based on the information on the type of the spectacle lens in the information provided from the terminal device 300. The minimum wall thickness and minimum edge thickness information is set in advance in consideration of strength depending on a type such as a material of the spectacle lens.

In S103, the object-side surface data-related information selection unit 230 of the LMS 200 selects information on optimum design data of the object-side surface based on the information on the type of the spectacle lens in the inquiry information of the terminal device 300 and the prescription value of the wearer.

In S104, the inquiry information transmission unit 240 of the LMS 200 transmits inquiry information, which includes not only the information provided from the terminal device 300 but also the information provided from the LMS including the minimum wall thickness and minimum edge thickness information and the optimum design data of the object-side surface, to the LDS 100. The LDS 100 may store the received inquiry information in the calculation data storage unit 150.

In S105, the object-side surface data selection unit 115 of the LDS 100 selects object-side surface design data based on the information on the optimum object-side surface design data.

In S106, the provisional design information calculation unit 120 of the LDS 100 calculates eyeball-side surface design data based on the prescription value of the wearer and the object-side surface design data.

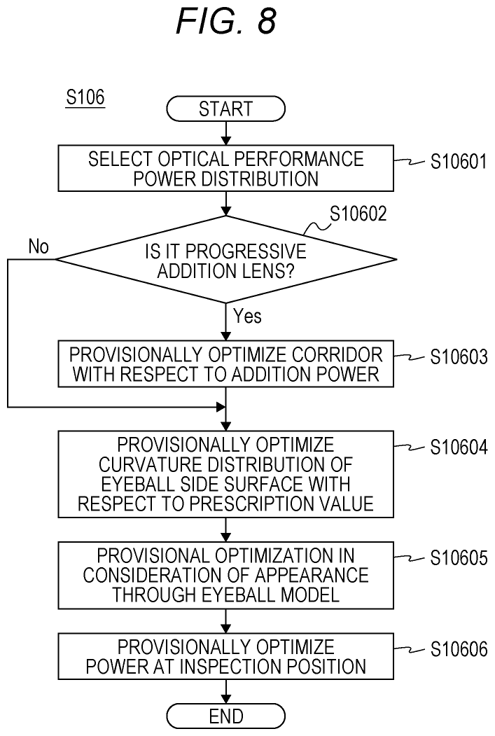

FIG. 8 is a flowchart illustrating an example of an operation of the provisional design information calculation unit 120 of the LDS 100 in provisional design data calculation S106.

In S10601, the optical performance power distribution selection unit 122 selects a power distribution of optical performance from the optical performance power distribution table 1210 based on the information on the type of the spectacle lens and the prescription value of the wearer.

Subsequently, in S10602 to S10606, the eyeball-side surface provisional design data calculation unit 123 calculates provisional design data of the eyeball-side surface based on the optical performance power distribution and the object-side surface design data.

In S10602, the eyeball-side surface provisional design data calculation unit 123 determines whether the spectacle lens is a progressive addition lens. If the spectacle lens is the progressive addition lens, the processing proceeds to S10603. If the spectacle lens is not the progressive addition lens, the processing proceeds to S10604.

In S10603, the eyeball-side surface provisional design data calculation unit 123 performs provisional optimization of a corridor with respect to addition power. Here, for example, an addition power optimization element is cut at a level that does not cause a large difference in wall thickness shape or an edge thickness.

In S10604, the eyeball-side surface provisional design data calculation unit 123 executes the provisional optimization of the curvature distribution of the eyeball-side surface with respect to the prescription value. At this time, the calculation time can be shortened by allowing the convergence condition to have a range.

In S10605, the eyeball-side surface provisional design data calculation unit 123 executes the provisional optimization in consideration of the appearance through the eyeball model. Here, the number of targets is thinned out to about half of the number of targets in S12105 to be described below.

In S10606, the provisional optimization of power at an inspection position is executed. Here, the tolerance of the optimization of the power at the inspection position is expanded by about twice to three times as compared with the tolerance of the final design data calculation unit 142. As a result, it is possible to shorten the calculation time while reducing the influence on the edge thickness.

Through the above steps, the provisional design data of the eyeball-side surface is calculated.

In S107, the provisional thickness information calculation unit 124 of the LDS 100 calculates provisional values of the wall thickness and edge thickness of the spectacle lens in accordance with the frame shape data based on the provisional design data of the eyeball-side surface, the design data of the object-side surface, and the minimum wall thickness and minimum edge thickness of the spectacle lens.

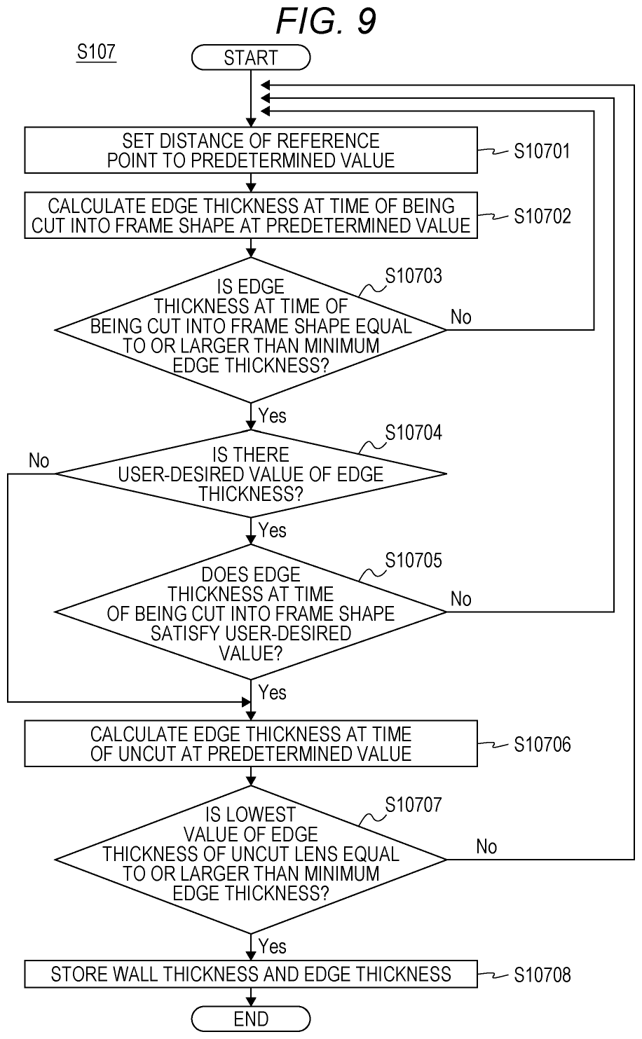

FIG. 9 is a flowchart illustrating an example of an operation of the provisional thickness information calculation unit 124 of the LDS 100 in S107.

In S10701, a distance between reference points of the object-side surface design data and the eyeball-side surface design data is set to a predetermined value. However, the predetermined value is set so as not to fall below the minimum wall thickness of the spectacle lens.

In S10702, an edge thickness at the time of being cut into the frame shape is calculated from the object-side surface design data and the eyeball-side surface design data based on the set predetermined value.

In S10703, it is determined whether the minimum edge thickness at the time of being cut into the frame shape is equal to or larger than the minimum edge thickness of the spectacle lens. In S10703, if the minimum edge thickness at the time of being cut into the frame shape is smaller than the minimum edge thickness of the spectacle lens, the processing returns to S10701, and the predetermined value is set such that the minimum value of the edge thickness at the time of being cut into the frame shape becomes larger. Then, the processing proceeds to S10702. In S10703, when the minimum value of the edge thickness at the time of being cut into the frame shape is equal to or larger than the minimum edge thickness of the spectacle lens, the processing proceeds to S10704.

In S10704, whether there is a user-desired value for the edge thickness is determined. If there is the user-desired value, the processing proceeds to S10705. On the other hand, if there is no user-desired value, the processing proceeds to S10706.

In S10705, whether the edge thickness at the time of being cut into the frame shape satisfies the user-desired value is determined. In S10705, if the minimum edge thickness when being cut into the frame shape exceeds the user-desired value, the processing returns to S10701, and the predetermined value is set such that the minimum value of the edge thickness at the time of being cut into the frame shape becomes smaller. Then, the processing proceeds to S10702. In S10705, when the minimum value of the edge thickness at the time of being cut into the frame shape is equal to or smaller than the user-desired value, the processing proceeds to S10706.

In S10706, an edge thickness of an uncut lens is calculated with the predetermined value set in S10701.

In S10707, it is determined whether the edge thickness of the uncut lens is equal to or larger than the minimum edge thickness of the spectacle lens. In S10707, if the edge thickness of the uncut lens is smaller than the minimum edge thickness of the spectacle lens, the processing returns to S10701, and the predetermined value is set such that the edge thickness of the uncut lens becomes larger. Then, the processing proceeds to S10702. In S10707, if the edge thickness of the uncut lens is equal to or smaller than the minimum edge thickness of the spectacle lens, the processing proceeds to S10708.

In the case of a plus lens, for example, the edge thickness of the uncut lens does not satisfy the minimum edge thickness of the spectacle lens even if the edge thickness at the time of being cut into the frame shape satisfies the minimum edge thickness of the spectacle lens in some cases.

In S10708, the calculated provisional values of the wall thickness and edge thickness are stored in the calculation data storage unit 150.

Returning to FIG. 7 again, the response transmission unit 130 of the LDS 100 transmits the provisional values of the wall thickness and edge thickness calculated by the provisional thickness information calculation unit 124 to the LMS 200 in S108.

In S109, the response transmission unit 255 of the LMS transmits the provisional values of the wall thickness and edge thickness received from the LDS 100 to the terminal device 300.

In S110, a calculation result is displayed on the operation display unit 71 of the terminal device 300.

The clerk of the optician's shop confirms user's intention.

In S120, the lens arrangement parameter calculation unit 141 of the LDS 100 calculates the lens arrangement parameter including the relative positional relationship between the spectacle lens in the lens arrangement and the eyeball based on the information on the spectacle wearing condition of the wearer and the provisional design information.

In S121, the eyeball-side surface final design data calculation unit 142 of the LDS 100 calculates final design data of the eyeball-side surface based on the prescription value of the wearer, the object-side surface design data, and the lens arrangement parameter.

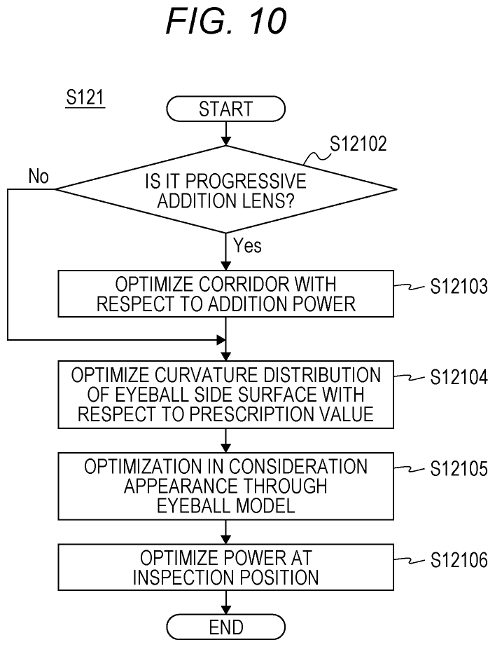

FIG. 10 is a flowchart illustrating an example of an operation of the eyeball-side surface final design data calculation unit 142 of the LDS 100 in S121.

In S12102, the eyeball-side surface final design data calculation unit 142 determines whether the spectacle lens is a progressive addition lens. If the spectacle lens is the progressive addition lens, the processing proceeds to S12103. If the spectacle lens is not the progressive addition lens, the processing proceeds to S12104.

In S12103, the corridor optimization unit 1421 optimizes the corridor with respect to the addition power. Here, the wall thickness shape and edge thickness are also added to the addition power optimization element.

In S12104, the prescription-value-coping curvature distribution optimization unit 1422 optimizes the curvature distribution of the eyeball-side surface with respect to the prescription value. At this time, the convergence condition is set strictly to calculate a more appropriate value.

In S12105, the virtual optical model optimization unit 1423 executes optimization in consideration of the appearance through the eyeball model. Here, the number of targets is twice or more the number of targets in S10605.

In S12106, the inspection power optimization unit 1424 executes the optimization of power at an inspection position. Here, the tolerance of power optimization at the inspection position is narrowed to about ½ to ⅓ times.

Through the above steps, the final design data of the eyeball-side surface is calculated, and a highly accurate value is obtained.

Returning to FIG. 7 again, the thickness information calculation unit 143 of the LDS 100 calculates values of the wall thickness and edge thickness of the spectacle lens in accordance with the frame shape data based on the derived final design data of the eyeball-side surface, the object-side surface design data, and the minimum wall thickness and minimum edge thickness of the spectacle lens in S122.

The thickness information calculation unit 143 in S122 performs the same operation as the provisional thickness information calculation unit 124 of the LDS 100 in S107, except that the final design data of the eyeball-side surface is used instead of the provisional design data of the eyeball-side surface.

The thickness information calculation unit 143 calculates the values of the wall thickness and edge thickness of the spectacle lens, and then, stores the calculation results in the calculation data storage unit.

Note that convergence calculation may be further executed after S122.

After contracting with the user, the clerk of the optician's shop transmits final order information from the terminal device 300 in S130.

In 5131, the final order transmission unit 265 of the LMS 200 transmits the final order information received by the final order reception unit 260 to the LDS 100.

In S132, the final design information transmission unit 170 of the LDS 100 transmits final design information to the LMS 200 in response to receiving the final order information received by the final order reception unit 160.

Thereafter, the producing process management unit 290 manages the producing process of the spectacle lens based on the final design information received from the LDS 100, whereby the ordered spectacle lens is produced.

Finally, the embodiment of the present disclosure will be summarized with reference to FIG. 3.

An embodiment of the present disclosure relates to a spectacle lens design system including:
an information acquisition means (for example, an inquiry information reception unit 110 and an object-side surface data selection unit 115) for acquiring a prescription value of a wearer, frame shape data, information on minimum wall thickness and minimum edge thickness of a spectacle lens, and design data of an object-side surface;
a first design data deriving means (for example, an eyeball-side surface provisional design data calculation unit 123) for deriving first design data of an eyeball-side surface based on the prescription value of the wearer and the design data of the object-side surface;
a first thickness information deriving means (for example, a provisional thickness information calculation unit 124) for deriving first values of wall thickness and edge thickness of the spectacle lens in accordance with the frame shape data based on the derived first design data of the eyeball-side surface, the design data of the object-side surface, and the minimum wall thickness and minimum edge thickness information of the spectacle lens;
a second design data deriving means (for example, an eyeball-side surface final design data calculation unit 142) for deriving second design data of the eyeball-side surface, which has higher accuracy than the first design data, based on the prescription value of the wearer and the design data of the object-side surface; and
a second thickness information deriving means (for example, a thickness information calculation unit 143) for deriving second values of the wall thickness and edge thickness of the spectacle lens based on the derived second design data of the eyeball-side surface, the design data of the object-side surface, and the minimum wall thickness and minimum edge thickness information of the spectacle lens.

According to one embodiment of the present disclosure, provided is the lens design system capable of quickly calculating the wall thickness and edge thickness of the spectacle lens in accordance with the frame shape.

The embodiment disclosed herein is an example in every respect and should not be restrictively understood. The scope of the present disclosure is defined not by the above description but by claims, and intends to include all modifications within meaning and a scope equal to claims.

### REFERENCE SIGNS LIST

100 LDS
200 LMS
300 terminal device
3 network

1. A spectacle lens design system comprising:
an information acquisition means for acquiring a prescription value of a wearer, frame shape data,
information on minimum wall thickness and minimum edge thickness of a spectacle lens, and design data of an object-side surface;
a first design data deriving means for deriving first design data of an eyeball-side surface based on the prescription value of the wearer and the design data of the object-side surface;
a first thickness information deriving means for deriving first values of wall thickness and edge thickness of the spectacle lens in accordance with the frame shape data based on the derived first design data of the eyeball-side surface, the design data of the object-side surface, and the minimum wall thickness and minimum edge thickness information of the spectacle lens;
a second design data deriving means for deriving second design data of the eyeball-side surface, which has higher accuracy than the first design data, based on the prescription value of the wearer and the design data of the object-side surface; and
a second thickness information deriving means for deriving second values of the wall thickness and edge thickness of the spectacle lens based on the derived second design data of the eyeball-side surface, the design data of the object-side surface, and the minimum wall thickness and minimum edge thickness information of the spectacle lens.

2. The spectacle lens design system according to claim 1, further comprising
a transmission means for transmitting the first values of the wall thickness and edge thickness of the spectacle lens.

3. The spectacle lens design system according to claim 1, further comprising
an optical performance power distribution deriving means for deriving an optical performance power distribution based on the prescription value of the wearer,
wherein the first design data deriving means comprises a first prescription-value-coping curvature distribution optimization means for optimizing a curvature distribution of an eyeball-side surface with respect to the prescription value of the wearer,
the second design data deriving means comprises a second prescription-value-coping curvature distribution optimization means for optimizing a curvature distribution of an eyeball-side surface with respect to the prescription value of the wearer, and
a tolerance of optimization in the first prescription-value-coping curvature distribution optimization means is wider than a tolerance of optimization in the second prescription-value-coping curvature distribution optimization means.

4. The spectacle lens design system according to claim 1, wherein
the first design data deriving means comprises a first virtual optical model optimization means for performing optimization in consideration of an appearance through an eyeball model,
the second design data deriving means comprises a second virtual optical model optimization means for performing optimization in consideration of an appearance through an eyeball model, and
a number of targets of the first virtual optical model optimization means is smaller than a number of targets of the second virtual optical model optimization means.

5. The spectacle lens design system according to claim 1, wherein
the first design data deriving means comprises a first inspection power optimization means for optimizing power at an inspection position,
the second design data deriving means comprises a second inspection power optimization means for optimizing power at an inspection position, and
a tolerance of optimization of the first inspection power optimization means is twice to three times a tolerance of optimization of the second inspection power optimization means.

6. The spectacle lens design system according to claim 1, further comprising
a lens arrangement parameter deriving means for deriving a lens arrangement parameter including a relative positional relationship between a spectacle lens of a lens arrangement and an eyeball based on information on a spectacle wearing condition of the wearer, design data of the object-side surface, the first design data of the eyeball-side surface, and the first values of the wall thickness and edge thickness of the spectacle lens,
wherein the second design data deriving means derives the second design data of the eyeball-side surface based on the prescription value of the wearer, the design data of the object-side surface, and the lens arrangement parameter.
